(19) United States
(12) Patent Application Publication
(10) Pub. No.: US 2005/0242592 A1
(43) Pub. Date: Nov. 3, 2005

(54) Pivotal bolt

(75) Inventor: John Russell Watts, Albert Park (AU)

Correspondence Address: SUGHRUE MION, PLLC, 401 Castro Street, Ste 220, Mountain View, CA, 94041-2007, US

(73) Assignee: Yarra Ridge Pty. Ltd., South Melbourne (AU)

(21) Appl. No.: 10/523,660

(22) PCT Filed: Aug. 5, 2003
(86) PCT No.: PCT/AU03/00984

§ 371 Date: Feb. 4, 2005

(30) Foreign Application Priority Data
Aug. 5, 2002 (AU) 2002950607
Nov. 28, 2002 (AU) 2002952981
Dec. 17, 2002 (AU) 2002953379
Feb. 19, 2003 (AU) 2003900725
May 13, 2003 (AU) 2003902294

(51) Int. Cl. E05C 19/10

(52) U.S. Cl. 292/95

(57) ABSTRACT

A lock for a displaceable wing (1) supported adjacent an opening (2) and having a closing edge (3) adjacent an element (4) defining the opening when the wing is closed; engageable means (5) mountable to the opening and including an entry aperture (6) connected to an offset aperture (7) of reduced width; a lock body mountable to the wing and including a casing (9) defined in part by a front edge (10) and an angularly displaceable bolt (11) having a leading edge (12) and at least one relatively protruding side shoulder (14), said bolt being displaceable about an axis orthogonal to the face of the wing and protruding from the front edge to engage the engageable means, said engagement being between the side shoulder (14) and the offset aperture which restrains the bolt and engageable means against relative displacement in a horizontal direction both parallel and orthogonal to the face of the wing.

### FIELD OF THE INVENTION

This invention relates to locks having at least one pivotal bolt.

The lock of [AU 633318 by Watts] may be adapted to include the improved bolt described herein and to include an improved strike plate. The improved strike in some forms takes features from that described in [AU 671618 by Watts].

### SUMMARY OF THE INVENTION

According to the invention there is a lock for a displaceable wing supported adjacent an opening and having a closing edge that is adjacent an element defining the opening when the wing is closed,
said lock including engageable means mountable to the opening and including an entry aperture connected to an offset aperture of reduced width,
and a lock body mountable to the wing and including a casing defined in part by a front edge and an angularly displaceable bolt having a leading edge and at least one side recess extending from the leading edge to define in part at least one relatively protruding side shoulder, said bolt being displaceable about an axis orthogonal to the face of the wing and intersecting the casing to protrude from the front edge of the casing to engage the engageable means whereby to restrain the wing from being displaced in an opening direction,
said engagement being characterized by engagement between the at least one side shoulder and the offset aperture,
said engagement restraining the bolt and engageable means against relative displacement in a horizontal direction parallel the face of the wing and in a horizontal direction orthogonal to the face of the wing.

In forms of the invention, the apertures provides free passage to the bolt when the bolt and aperture are relatively disposed within a vertical range of dispositions and within a range of gap between the aperture and lock body,
said engageable means and bolt being engageable when the bolt and aperture are disposed within a vertical range of relative dispositions and within a range of gap between the aperture and lock body.

In forms of the invention, the entry aperture has a width substantially the same as the bolt and including an additional incremental width to provide working clearance between the bolt and aperture edge

In forms of the invention, the side recess and protruding shoulder are defined in part by a recess radius.

In forms of the invention, the protruding shoulder is defined in part by an outer radius.

In forms of the invention, engagement is characterized by the relatively protruding side shoulder overlaping the edge of the offset aperture.

In forms of the invention, the leading edge is substantially horizontal when the bolt is engaged with the engageable means.

In forms of the invention, the engageable means comprises a strike plate having a wing and the wing comprises a hinged door.

In forms of the invention, the bolt comprises an outwardly biased latch bolt characterized by a pre-latching, partly extended position and the engageable means comprises a strike plate having a wing.

In forms of the invention, the latchbolt leading edge at the outer radius is radiused, curved, bevelled or otherwise profiled on both sides to enable the bolt to be engaged on either side to be inwardly displaced by the strike plate during latching whereby to be suitable for both left hand and right hand hinged doors.

In forms of the invention, the strike plate has an entry aperture and an upper and lower offset recess whereby to render it suitable for both left hand and right hand hinged doors.

In forms of the invention, the bolt has a side recess on both sides

In forms of the invention, the strike plate includes a first portion comprising a substantially planar portion that includes the apertures connected to an angled or curved wing and second portions comprising portions fixable to the opening by screws and connected to the first portion by bridge portions of reduced strength,
said first portion and bridge portions being deformable by the bolt whereby to enable the offset aperture and surrounding material to be displaced horizontally away from the element defining in part the opening and fixable portions.

Preferably, the deformation of the strike plate occurs at reduced forces whereby to enable the bolt to remain engaged with the strike plate without substantially affecting the integrity of the screw fixing in the opening.

According to the invention, there is a lock substantially as described herein with reference to and as illustrated in the accompanying drawings.

### DESCRIPTION OF THE PREFERRED EMBODIMENTS

### DESCRIPTION OF THE DRAWINGS

Embodiments of the present invention will now be described by way of example only with reference to the accompanying drawings in which:

FIG. 1 is an isometric view of a wing supporting a lock body with extended bolt,

FIG. 2 is an isometric view of a lock body,

FIG. 3 is an isometric view of a strike plate,

FIG. 4 is a view of the bolt of FIG. 1 engaged within the strike plate when the strike plated is disposed at +4 MM with a maximum gap,

FIG. 5 is a view of the bolt of FIG. 1 engaged within the strike plate when the strike plated is disposed at −4 MM without a gap.

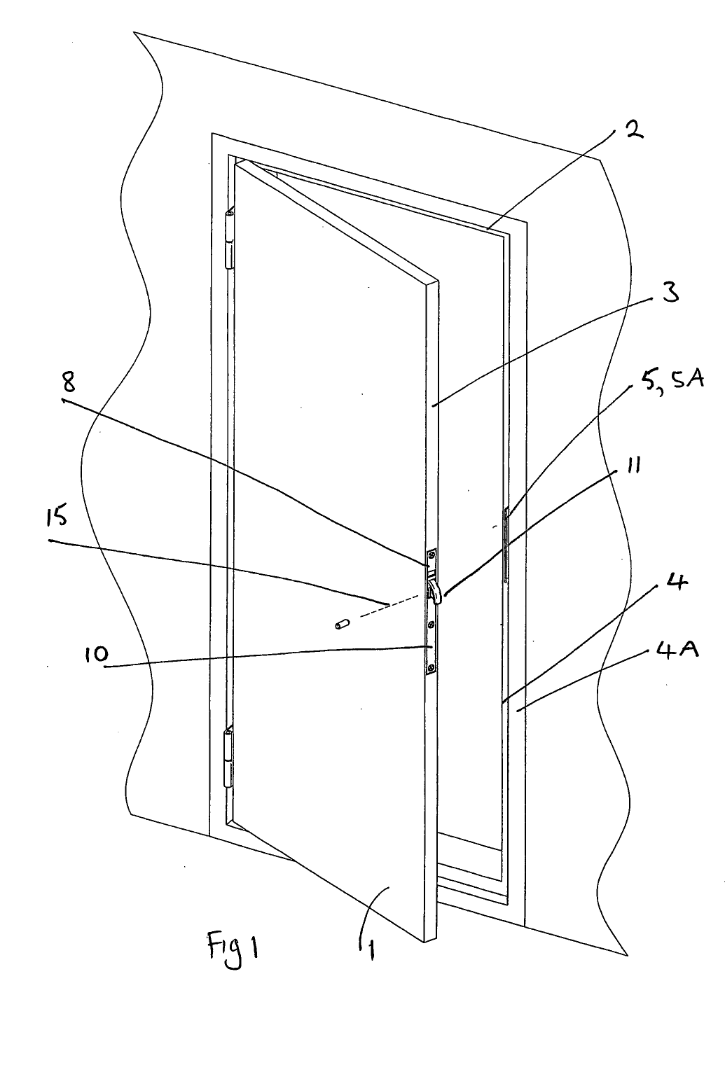

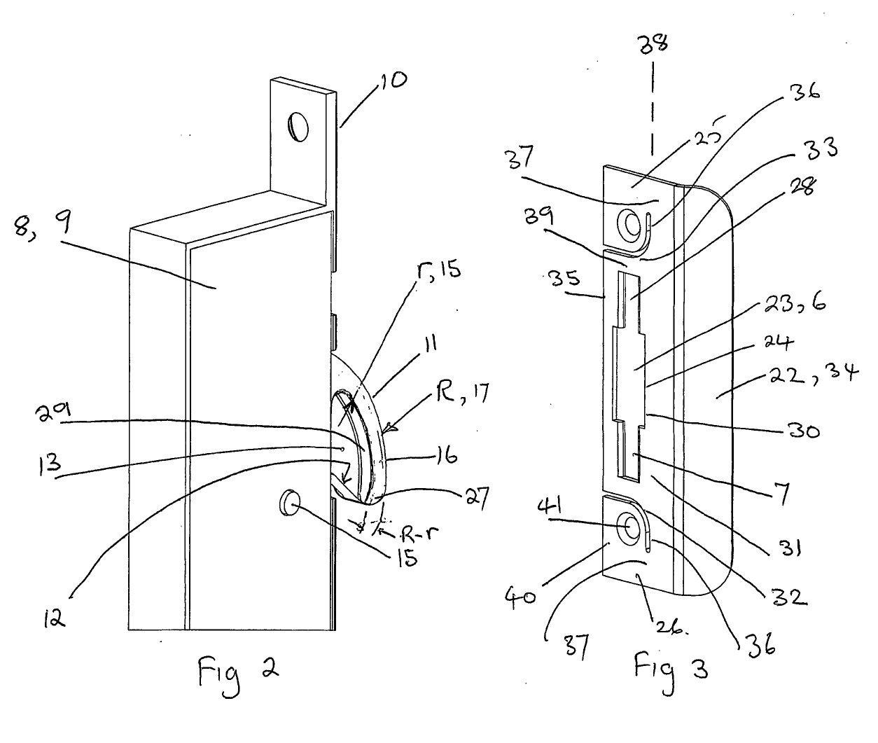

### DEFINITIONS AND CONVENTIONS EMPLOYED

This specification describes “locks” (as defined below) substantially as described herein with reference to and as illustrated in the accompanying drawings.

Throughout this specification and claims which follow, unless the context requires otherwise, the word “comprise”, or variations such as “comprises” or “comprising”, will be understood to imply the inclusion of a stated integer or group of integers but not the exclusion of any other integer or group of integers.

Throughout this specification and claims which follow, unless the context requires otherwise, the positional prepositions such as rear, forward are used to assist in description of the preferred embodiments and with reference to the accompanying drawings and have in general no absolute significance.

Throughout this specification and claims which follow, unless the context requires otherwise, the word wing embraces both displaceable doors and windows and the word door embraces wings; and the word opening includes elements that define the opening, such as a doorjamb.

Throughout this specification and claims which follow, unless the context requires otherwise: latching means displacement of the latch bolt against biasing means by an engageable means and subsequent displacement of the latch bolt into engagement with the engageable means under the action of the biasing means, in the case of a hinged door and latch bolt, the engageable means comprising a strike plate having an engageable aperture, in the case of a sliding door and hook bolt, the engageable means comprising a catch plate having an engageable aperture; latch bolt is an outwardly biased bolt capable of executing latching; auxiliary bolt means an outwardly biased plunger that is operably associated with the latch bolt; unlatching means withdrawal of the latch bolt from engagement with the engageable means; unlatching lever is a lever or knob that is hand operable to cause the latch bolt to become disengaged; locking means configuring the lock to restrain it from becoming unlatched; deadlocking means means means to configure the lock to restrain the latch bolt from being displaced from the configuration that it assumes when engaged with the engageable means (and in the case of a rectilinearly displaceable bolt, a fully extended position); deadlatching refers to automatic deadlocking of the bolt during latching of the bolt—i.e. the bolt becomes deadlocked as a result of latching; security doors means a door comprising a hollow framed with an in-fill where the hollow within the frame is comparatively small in depth and in width—some security doors having a close weaved infil material, some having expanded aluminium mesh; lock body is the lock portion fitted within the hollow frame of the wing and includes a substantially hollow box-like casing having a bolt aperture in the front edge to provide passage for the bolt; handle set is a subassembly comprising a hand operable lever supported within a backplate, a lockset in some forms comprising an exterior handle set, and an interior handle set each supported against a face of the wing and a lock body therebetween connected by a rod or rods to the adjacent operable levers; free-rotation-cylinder (also called a free-movement-cylinder) is a cylinder comprising a key operable barrel within a cylinder housing connected to a first cam (in one form [and commonly] having a radially protruding arm) with free movement, said free-rotation-cylinder preferably comprising a double cylinder sub-assembly comprised of opposed barrels each connected with free movement to the same first cam such that the first cam is free (between limits) to be angularly displaced while the barrels remain undisplaced. This type of (free rotation) cylinder is commonly used in security door locks in Australia—it enable the cam to be displaced by either barrel to a locking configuration and then the barrel to be reverse rotated to an undisplaced position enabling key removal while leaving the cam in the locking position. This type of cylinder is distinct from more commonly used double cylinders that employ clutches and that do not have free rotation between the barrels and first cam.

This application describes inventions comprising improved complete locks for displaceable wings and improvements for locks for displaceable wings.

The invention includes all material within “Definitions and Conventions Employed” of this specification.

The improved bolt described herein is applicable to all locks having at least one pivotal bolt and is particularly suited to the lock described in [Watts 633318] which is included herein by reference. The lock of 633318 is for a displaceable wing having both interior and exterior sides and a closing edge that abuts an opening supporting a strike plate when the door is closed. The lock is attachable to the closing edge such that when the wing is closed and the bolt is engaged in the strike plate the wing is restrained from displacing in an opening direction. For hinged doors the lock includes a strike plate (having a curved or angled) wing to facilitate latching wherein both an auxiliary bolt and pivotal bolt are inwardly displaced by the strike plate wing as they slide up the strike plate wing as the wing is closed (the closing edge of the wing travelling in a direction substantially orthogonal to a face of the door at latching)—this being well known.

The bolt is supported within a lock casing (comprising part of a lock body that is located within the wing frame defining the closing edge) about a horizontal axis orthogonal to a face of the door and preferably comprising by a pinned cylindrical protrusion of the casing but it preferably comprises a steel rivet that passes from one sise of the lock casing to the other to provide good support for the bolt.

The bolt of [Watts 633318] is better called a latch bolt because it is outwardly biased (by a spring supported about the rivet having one end fixed within the casing and the other fixed within the bolt) to be displaceable to the fully extrended position under the action of the biasing means. It employs an auxiliary bolt to restrain the latch bolt in a partly extended pre-latching position to facilitate latching. The bolt is displaceable by operating means (including at least one operable lever positioned on a face of the wing) from a fully extended position where it protrudes from the casing to a retracted position where it is substantially within the casing and where it is disengaged from the strike plate, and is displaceable from the retracted position to the pre-latching position by biasing means, and is displaceable from the retracted position to the fully extended position by biasing means. The latch bolt of [Watts 633318] comprises, in general, a segment of a solid cylindrical disc defined in part by an outer radius and a general thickness and bounded by two angularly spaced edges including a leading edge that is displaceable from the casing, and preferably having a hook-like shoulder (27 in specification Watts 633318) protruding from the leading edge. The strike plate is configured such that when engaged by the bolt, the hook lies behind the peripheral edge of the aperture; i.e. this portion of the bolt is behind a portion of the strike plate restraining the bolt (and wing) against horizontal displacement in an opening direction.

The auxiliary bolt has an undisplaced position where it protrudes from the casing and an inwardly displaced position that it is displaced to by either the catch plate or strike plate. In the case of the lock of [Watts 633318], there is a displaceable arm having a free end terminating in an engageable shoulder. The engageable shoulder is biased towards the latch bolt and in the pre-latching configuration the shoulder is engaged with the latch bolt to restrain it from outwardly displacing. Inwards displacement of the auxiliary bolt causes the free end engageable shoulder to displace from the locus of movemnt of the latch bolt to thereby enable it to be displaced to he fully extended position.

In other forms the auxiliary bolt includes a return portion (having an engageable shoulder) within the casing that in the pre-latching position is engaged directly with latch bolt to restrain it from being outwardly displaced—and where inwards displacement of the auxiliary bolt causes the shoulder to displace from the locus of movement of the latch bolt to thereby enable it to be displaced to the fully extended position.

In sliding wings both the auxiliary bolt and pivotal bolt are inwardly displaced by the catch plate (a member similar to the stike plate but without a wing) as the door is displaced in a direction parallel a face of the door and towards the catch plate.

Although, some of the material above was said to originate from [Watts 633318] and to describe the invention within [Watts 633318] it is also relevant to the inventions described herein and is to be considered part of the inventions decribed herein.

The bolt, subject of this specification, provides improved engagement between a strike plate and the bolt. It is not limited to application in a lock as described above but it does provide a solution to one of the few short comings of the lock of [Watts 633318]—this being that the bolt only overlaps the strike plate by the length of the hook and for practical reasons, including strength of the bolt, this cannot exceed a limited predetermined length and this length must also accommodate a clearance for the wing dropping and a clearance for imperfect fiiting by the wing installer, both being deducted from the possible overlap.

Although the lock described above employs a latch bolt having a pre-latching configuration, the inventions subject of this invention are also applicable to all types of locks employing a pivotal bolt, including those where the bolt is directly connected to a hand operable lever.

The invention described herein is suitable for a displaceable wing 1 supported adjacent an opening 2. The wing has a closing edge 3 that is adjacent an element 4 that defines the opening when the wing is closed. In the case of hinged doors, the free edge of the door is adjacent the door jamb 4A when the door is closed and it is on this free edge that the lock body 8 is mounted. The lock body includes a casing 9 having a front edge 10 and a angularly displaceable bolt 11 that is displaceable about an axis 15 that is orthogonal to the face of the wing and that intersects the casing, said bolt being displaceable to a position where it protrudes from the casing relative to the front edge to engage the engageable means. In forms of the invention the front edge includes a bolt aperture to provides passage for the bolt.

The improved bolt preferably comprises a segment of a substantially solid parallel sided cylindrical disc defined in part by an outer radius R, 17 referenced from the bolt pivotal axis and having a general thickness T (excluding recesses) and bounded by two spaced edges including a leading edge 12, (said edges preferably comprising angularly spaced substantially radial edges), said improved bolt being displaceable from the casing. Within at least one one side of the bolt, between the pivotal axis and outer edge, extending from the leading edge is a side recess 13 that is preferably defined by an outer recess radius r, 15 that does not extend to the outer edge and so leaving a sidways relatively protruding shoulder 14 (“relatively” meaning that the shoulder may be within the general thickness but in relation to the the adjacent side recess it comprises a sideways protruding shoulder).

The relatively protruding shoulder preferably comprises an arcular shoulder 16 defined in-part by the outer radius R and defined in-part by the recess radius r of the adjacent preferably, substantially planar side recess; and the side recess is preferably planar and defined by a normal vector that is parallel to the pivotal axis of the bolt. The plane of the side recess, relative to the general shape of the bolt, is at a depth of t

The relatively protruding shoulder thereby having a radial width of R-r, 20 and a relative height of t and the thickness of the bolt through the recess (herein called the web thickness) is equal to T-t, 21

Preferably each side of the bolt is profiled as described above so that the width of the bolt between side recesses is T-2t.

Although preferable (that in general) the outer edge of the bolt has a constant radius R, and the side recess be defined by a constant radius these configurations are not essential to the inventions herein. However, this form provides the advantage that the strike plate, once aligned to enable the bolt to enter the entry aperture will provide free passage to the bolt over its full range of displacement; and if the bolt is displaced relative to the strike plate when in the fully extended position to become in contact with the strike plate, it can be displaced to withdraw from the strike plate aperture without having to in any way deform the strike plate. If the bolt is also urged against the strike plate it can be displaced (by overcoming frictional forces) to withdraw from the strike plate aperture and again without having to deform the strike plate.

The improved engageable means 5 that for hinged doors comprises a strike plate 5A, compatable with the improved bolt comprises in one form a substantially conventional strike plate having a wing 22 to facilitate latching, an aperture 23 to provide passage for the bolt and having a periphral edge 24 and upper 25 and lower 26 portions that are attachable (usually by screws) to the element defining the opening.

The aperture however, is adapted to include an entry aperture 6 having a substantially conventional width (to allow entry of the protruding shoulder with a little clearance) and a lower offset recess 7 connected to the entry aperture but being of reduced width to allow entry of just the web of the bolt with a little clearance. The width of this offset recess is less than T but greater than T-t or T-2t, depending on whether the bolt has one or two side recesses.

The bolt and strike plate dimensions are configured such that during latching each annular shoulder enters the entry aperture and the web enters the offset recess. When the bolt is fully extended a portion of each annular shoulder horizontally overlaps a peripheal edge of the offset recess—and if one ignores relatively small working clearances by t.

A lock as described above having a given outer radius, given side recess radius and pivotal axis and casing, fitted within a wing and having the strike plate described above attached to the opening, will be separated (when the wing is closed) by a gap 26. In practice, this distance should not exceed (herein defined as) a “maximum gap” and related to this maximum gap is a predetermined (herein defined) minimum overlap and when the lock and strike plate are more closely disposed the overlap will be greater than it is for the maximum gap. Preferably the bolt and strike plate aperture are configured to maximize the minimum overlap while observing other considerations described below

It will also be appreciated from looking at the figures that the larger is r the larger will be the overlap; and the larger is r the weaker will be the protruding shoulder that has a width of R-r. Preferably (and for other reasons) r can be maximized but not so as to undesireably weaken the shoulder.

When the lock is a lock for hinged doors and the improved bolt takes the form of a latch bolt, the portion of the bolt defined by the intersection of the leading edge and the outer edge of one side of the protruding shoulder is preferably radiused, sperical or otherwise curved or profiled 27 to enable this portion to slide up the wing of the strike plate during latching. For practical reasons, it is preferable that both sides of the bolt be so configured to suit both left hand and right hand hinged doors. In some

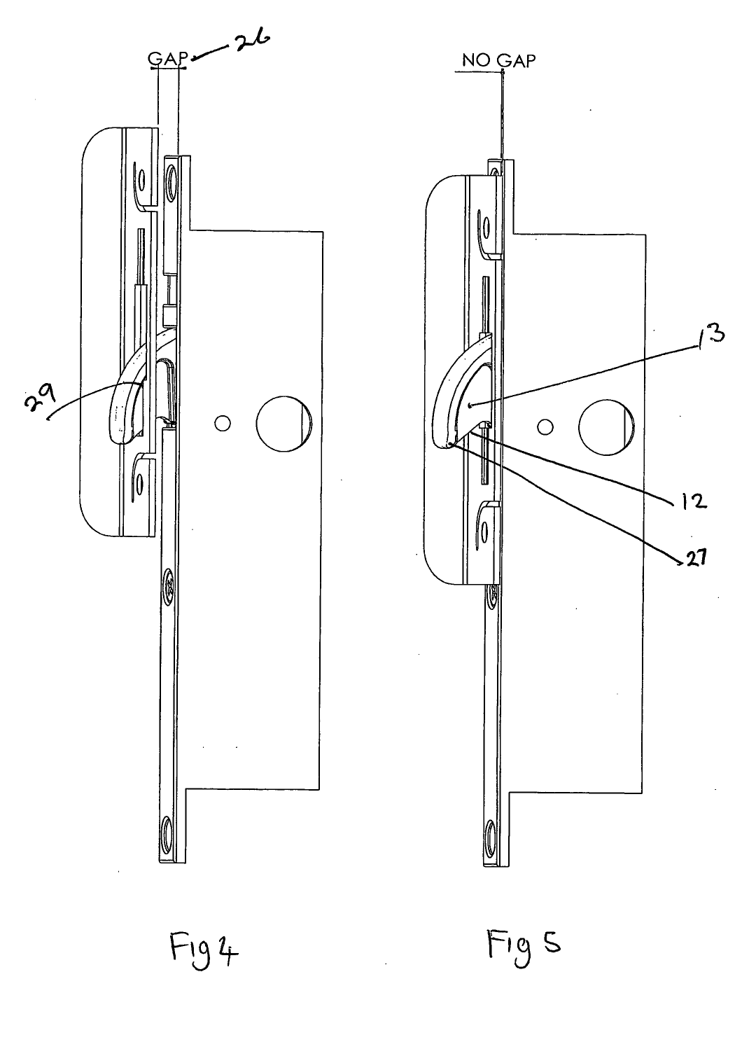

Because wings sometimes drop after fitting and because of wing installation errors it is preferable that the bolt and strike plate properly engage within a range of vertical relative disposition and in practice it has been found necessary for this range to extend from −4 MM to +4 MM about a nominal central position. This means that the bolt must be able to enter and withdraw from the aperture and overlap the aperture when engaged. So the bolt and strike plate of the inventions are further configured to function correctly and to have maximum “minimum overlap” within the range from 4 MM below the nominal central position to 4 MM above while observing other considerations described below as shown in FIG. 3 and FIG. 4.

The derived improved catch plate has a substantially rectangular entry aperture having an upper edge (excluding working clearances) in horizontal alignment with the upper edge of the bolt when the gap is zero and the strike plate is relatively disposed at −4 MM from the central position. The lower edge of the entry aperture is in contact with (to be limited by) the inner wall of the protruding shoulde of the bolt when the gap is maximum and the strike plate is relatively disposed at +4 MM from the central position. The lower end of the offset aperture is substantially horizontally aligned with the leading edge when the bolt is fully extended and the strike plate is relatively disposed at +4 MM from the central position.

By configuring in this way, an overlap is obtained that meets all the criteria and that is significantly greater than the overlay of the hook of the bolt of [Watts 633318].

For practical reasons, the aperture is further configured so as to suit both left hand and right hand hinged doors and so the aperture is further configured to be a mirror image about a plane through the centre of the entry aperture and to have an upwardly extending second offset 28 recess that is only used if the strike plate is inverted.

In forms of the invention offset aperture edge is further configured so that when the gap is maximum and the strike plate is central, the inside edge 29 of the side shoulder is in contact with the strike plate underside that has been formed to mate with the bolt over an extended distance; i.e. this portion of the strike plate is not flat and has been formed by being displaced away from the lock casing so as to have a greater area of contact with the bolt.

Although the description above (and including earlier description relating to 66618) refers to a lock for hinged wings that may comprise doors, and having a bolt and a strike plate having a wing, the material is equally as relevent to a lock for sliding wings having a catch plate with an aperture as desccribed above. (The catch plate in one form comprise the improved strike plate described above but because it is unnecessary for a sliding wing to employ a wing, this is omitted in some forms, in other forms again, the aperture may be displaced from the wing opening to provide clearance for the bolt to fit between the opening and underside of the catch plate aperture.)

In some forms of locks there are multiple bolt as described above each being engageable behind the peripheral edge of an offset aperture and each having passage through an entry aperure.

In some forms of locks, the bolt comprises a latch bolt having a pre-latching configuration as does the lock of [Watts 633318] and the bolt is controlled by an auxiliary bolt.

When doors are jemmied or burst open, it is common for the bolt to be displaced longitudinally from the aperture and in locks having rectilinearly displaceable bolts there is nothing to stop the bolt from being rectilinearly displaced from the aperture while the opening and closing edge of the wing are forced relatively apart. Where the bolt and strike plate take the preferred form described above, each sideways protruding shoulder locates behind a peripheral edge of the offset aperature so that attempted relative horizontal displacement to part the wing and opening brings the inside edge of the protruding shoulder and inside side wall into contact with the edge of the offset recess so that that the strike plate is able to provide a force resisting futher relative displacement. If the forces applied are sufficiently large, futher relative displacement will occur causing the portion of the strike plate plate adjacent the offset recess to be displaced with the bolt.

The apertures of the improved strike plate include a front edge 30 (said edge including the front edge of the entry aperture and/or the front edge of the offset apertures) against which the bolt is urged when the door is urged in an opening direction as occurs when one attempts to force open a locked door. The substantially conventional strike plate in preferred forms, is futher modified to resist jemmying by enabling the portion of the strike plate plate adjacent the offset recess to be displaced with the bolt while the portion attached to the opening remain attached to the opening while being subjected to forces that tend to pull the strike plate away from the opening and that urge the fixing scews to pull out, however the further modified strike plate subjects the screws to considerably lower forces than are applied by a conventional strike plate. The apertures of this strike plate are within a substantially flat plate-like portion 31 extending from between a lower slot 32 to an upper slot 33 and connected to the strike plate wing 34 that preferably comprises an angled or curved wing and each said slot extends from the rear edge 35 to pass between the fixing aperture and offset aperture and preferably each slot further extends to include a vertical portion 36 between the screw aperture and wing. Importantly, the front edge of the aperture is within a portion of the strike plate that is connected to the wing so as to be displaced with the wing.

The strike plate wing is connected by bridges 37 of reduced cross-sectional area and the strike plate is of a deformable material enabling these bridges to deform without cracking and the reduced areas enables deformation to occur at reduced forces—these characteristics enabling the wing to be angularly displaced about a deformation axis 38 that passes substantially through each bridge. If forms where the front edge is rearwardly disposed relative to this deformation axis, rotation of the wing causes the front edge to be displaced towards the wing and bolt to bring the bolt into closer engagement with the strike plate. When a jemmy blade rests on the strike plate wing as it is rotated to part the wing from the opening, the blade angularly displaces to deform the bridges and to cause the wing to rotate about the deformation axis.

The upper and lower extremes 39 of the plate-like portion (that portion between the apertures and the slots), are of reduced cross-sectional area to enable these portions to deform under low forces so as to deform as the blade portion angularly displaces about th deformation axis. When these portions are caused to engage the face of the lock they deform so as not to inhibit the displacement of the wing about the deformation axis.

The bridges connect to fixable portions 40 that include screw apertures 41 through which screws shanks have passage and by which the fixable portion is attached to the opening. In some types of deformation the fixable portions angularly displace about the screw to reduce the effective distance between bridges, and this feature combined with the fact that the wing is attached only at each to a bridge enables the wing and front edge to deform like a bow and at comparatively moderately low forces to thereby enable the front edge to displace with the bolt while the fixable portions remain attached to the opening while being subjected to reduced loads that urge the screws to pull out of the opening.

In common forms of jemmy attack, when a closed and locked door is urged open under the action of a jemmy blade placed adjacent the bolt, the bolt is forced against the front edge while the lock is simultaneously displaced away from the strike plate and as a result, the bolt (in part, as a result of friction between the bolt and front edge) causes the strike plate to deform to enable the front edge to displace with it.

Other alternative forms of bolt are feasible such as sideways protruding cylindrical shoulders projecting from a generally planar form but this form has less strength and there is the risk of the shoulders being “caught” within the aperture as the bolt is displaced to withdraw from the aperture, and particularly if the bolt is not perfectly aligned with the catch plate. This form of bolt also provides less resistance to bending about an axis through the front edge of the lock body and therefore is more likely to bend when an attempt is made to force open a wing. Alternatively, the web can be omitted from the bolt but a bolt so constructed when urged horizontally from the aperture is more likely to deform to release the catch plate.

In some forms of locks employing a preferred bolt, the bolt is restrainable in the fully extended position by a deadlocking slide that is displaceable to be disposed behind the bolt to restrain it from being inwardsly displaced [Watts 633318]. In forms of locks, the deadlocking slide is operable by both a key operable cylinder and a hand operable interior lever as described in [Watts 633318]

1. A lock for a displaceable wing supported adjacent an opening and having a closing edge that is adjacent an element defining the opening when the wing is closed,
said lock including engageable means mountable to the opening and including an entry aperture connected to an offset aperture of reduced width,
and a lock body mountable to the wing and including a casing defined in part by a front edge and an angularly displaceable bolt having a leading edge and at least one side recess extending from the leading edge to define in part at least one relatively protruding side shoulder, said bolt being displaceable about an axis orthogonal to a face of the wing and intersecting the casing to protrude from the front edge of the casing to engage the engageable means whereby to restrain the wing from being displaced in an opening direction,
said engagement being characterized by engagement between the at least one side shoulder and the offset aperture,
said engagement restraining the bolt and engageable means against relative displacement in a horizontal direction parallel the face of the wing and in a horizontal direction orthogonal to the face of the wing.

2. A lock according to claim 1, wherein the entry aperture provides free passage to the bolt when the bolt and entry aperture are relatively disposed within a vertical range of dispositions and within a range of gap between the entry aperture and the lock body,
said engageable means and bolt being engageable when the bolt and the entry aperture are disposed within a vertical range of relative dispositions and within a range of gap between the entry aperture and lock body.

3. A lock according to claim 1, wherein the entry aperture has a width substantially the same as the bolt and including an additional incremental width to provide working clearance between the bolt and the entry aperture.

4. A lock according to claim 1, wherein the side recess and protruding shoulder are defined in part by a recess radius.

5. A lock according to claim 1, wherein the protruding shoulder is defined in part by an outer radius.

6. A lock according to claim 1, wherein engagement is characterized by the relatively protruding side shoulder overlaping the edge of the offset aperture.

7. A lock according to claim 1, wherein the leading edge is substantially horizontal when the bolt is engaged with the engageable means.

8. A lock according to claim 1, wherein the engageable means comprises a strike plate having a wing and the wing comprises a hinged door.

9. A lock according to claim 1, wherein the bolt comprises an outwardly biased latch bolt characterized by a pre-latching, partly extended position and the engageable means comprises a strike plate having a wing.

10. A lock according to claim 9, wherein a leading edge of the latch bolt at the outer radius is radiused, curved, bevelled or otherwise profiled on both sides to enable the bolt to be engaged on either side to be inwardly displaced by the strike plate during latching to provide for operability with both left hand and right hand hinged doors.

11. A lock according to claim 10, wherein the strike plate has an entry aperture and an upper and lower offset recess to provide for operability with both left hand and right hand hinged doors.

12. A lock according to claim 1, including a bolt having a side recess on both sides.

13. A lock according to claim 8, wherein the strike plate includes a first portion comprising a substantially planar portion that includes the entry and offset apertures connected to an angled or curved wing and second portions comprising portions fixable to the opening by screws and connected to the first portion by bridge portions of reduced strength,
said first portion and bridge portions being deformable by the bolt whereby to enable the offset aperture and surrounding material to be displaced horizontally away from the element defining in part the opening and fixable portions.

14. A lock according to claim 12, wherein the deformation of the strike plate's first and bridge portions occurs at reduced forces whereby to enable the bolt to remain engaged with the strike plate without substantially affecting the integrity of the screw fixing in the opening.

15. (canceled)
